(19) United States
(12) Patent Application Publication
(10) Pub. No.: US 2022/0023682 A1
(43) Pub. Date: Jan. 27, 2022

(54) DUAL PURPOSE ELASTIC BAND STRUCTURE FOR POSITIONING A REUSABLE WOVEN FABRIC FACE COVERING AND MASKS HAVING THE SAME

(71) Applicant: VELMA TOY HUNG LEE, POTOMAC, MD (US)

(72) Inventor: VELMA TOY HUNG LEE, POTOMAC, MD (US)

(21) Appl. No.: 17/382,206

(22) Filed: Jul. 21, 2021

Related U.S. Application Data
(60) Provisional application No. 63/055,500, filed on Jul. 23, 2020.

(51) Int. Cl. A62B 23/02; A41D 13/11; A62B 18/08

(52) U.S. Cl. CPC A62B 23/025; A62B 18/084; A41D 13/1161

(57) ABSTRACT

A reusable woven fabric face covering mask that includes a woven fabric face covering that has elastic ear loops on each side and an elastic connecting band has two distal ends each of which include a loop surrounding one of the ear loop. Additionally, a tented mask construction achieved from a simple two-layer face covering through the use of folding and structural seams.

### CLAIM TO BENEFIT OF PROVISIONAL APPLICATION

Applicant claims the benefit of provisional application No. 63/055,500 filed Jul. 23, 2020.

### FIELD OF THE INVENTION

The present invention relates to reusable woven fabric face coverings optimized for comfort and convenience though innovative structural design and the use of a combination of ear loop attachments and a connector band to balance the elastic attachment forces on the wearer's ear and provide optimal positioning when the mask is not being worn.

### BACKGROUND

Face masks that cover the nose and mouth of the wearer to filter air and contain fluid droplets to reduce the airborne droplet transmission and/or prevent the spread of germs are well known. Until recently most such masks were disposable medical masks or respirators made of non-woven fibrous filter material often molded to fit over the mouth and nose of a wearer. N95 respirators and surgical masks are examples of personal protective equipment that are used to protect the wearer from airborne particles and from liquid contaminating the face.

A surgical mask is a loose-fitting, disposable device that creates a physical barrier between the mouth and nose of the wearer and potential contaminants in the immediate environment. These are often referred to as face masks, although not all face masks are regulated as surgical masks. The edges of the mask are not designed to form a seal around the nose and mouth.

An N95 respirator is a respiratory protective device designed to achieve a very close facial fit and very efficient filtration of airborne particles. Note that the edges of the respirator are designed to form a seal around the nose and mouth. Surgical N95 Respirators are commonly used in healthcare settings and are a subset of N95 Filtering Facepiece Respirators (FFRs), often referred to as N95s.

Neither surgical masks nor respirators are intended for reuse without medical grade decontamination.

In the wake of the COVID-19 pandemic, the CDC recommends that members of the public use simple cloth face coverings when in a public setting to slow the spread of the virus, since this will help people who may have the virus and do not know it from transmitting it to others. While disposable medical masks provide the requisite protection, such masks are not intended for reuse and it is impractical for entire populations to use disposable masks.

Thus, there is a need for reusable woven fabric cloth face coverings that provide sufficient coverage and are comfortable for the user. In practice comfort and convenience are important factors in encouraging widespread mask use. In ordinary use, the user may switch from face covered to face uncovered frequently.

Reusable woven fabric face coverings take on various forms, the most popular of which may be described as pleated masks and cup masks along with some attempts at tent mask structures. Each of these mask types typically include ear loops or sometimes one or more bands for attachment around the back of the head to retain the mask over the wearer's nose and mouth. There are advantages associated with providing a face covering that attaches over the wearer's ears rather than looping around the back of the head. The mask may be easier to put on and take off. Also, bands that extend around the back of the wearer's head may become entangled in the wearer's hair or otherwise ruin the wearer's hair style.

Ear loops are also common in the context of disposable medical masks, but it is also known to provide a lengthy drop-down band on the mask. A drop-down band allows the mask to be retained around the wearer's neck when the mask is not being worn over the nose and mouth. In this manner, the mask is retained at the mid-section of wearer's chest and does not need to be stored. This provides for quickly accessing the mask to reposition over the wearer's nose and mouth. The drop-down feature also frees the wearer's hands to perform other tasks. If a mask is inconvenient to put on or take off or is not readily available and accessible when not worn, the wearer is less likely to put the mask on, creating health hazards.

Although masks are known which provide a drop-down feature, and other masks are known which provide ear loop attachments, most masks include one or the other, not both. However, U.S. Pat. No. 5,819,731 describes a medical mask that provides both drop down retention as well as a form of ear loop attachment achieved by threading the band through the mask. The mask utilizes a band that is fixed at one attachment point on each side of the mask and threaded through an opening and slidable at a second attachment point on each side of the mask so that band can extend tightly around the ears of the wearer to support the mask against the wearer's face over the nose and mouth. The band attaches at each side of the mask near either the upper or the lower portion. An orifice or other retainer guide that provides for slidably retaining the band is located at each side of the mask and in spaced apart relationship to an attachment point for each end of the band. The band may be continuous around the back of the neck or two separate sections may be tied or clipped together. This configuration provides for four attachment points (two on each side, one fixed, one slidable) and fits around the back of the ears in a way that pulls the band against the ears.

### SUMMARY

The present invention provides an elastic connecting band and a reusable woven fabric face covering mask that includes a woven fabric face covering that has separate elastic ear loops on each side and a separate elastic connecting band that has two distal ends each of which include a loop surrounding one of the ear loops. The elastic band construction may be used to retrofit existing ear loop masks when releasable loop connections (e.g., snap or Velcro) are provided.

The invention also provides a novel tent-type mask construction and method of making the same. The tent-type mask configuration includes side portions that lay flat on the wearer's face and are tensioned by flat elastic bands pulling the side portions across the face toward the ears. A connecting band is adjustable along the ear loops to balance the elastic force of the loop ends to optimize user comfort and direct the elastic force away from the back of the ear an tangent to the top and bottom of the ear. From the side portions of the face covering that lie flat on the face, the face covering is tented outward by virtue of novel folding, creasing and seaming assembly method described that causes and portion of the face covering to tent away from the wearer's mouth. This tented configuration combined with the force distribution and balance of the connecting band optimizes the mask experience for many wearers, especially when talking.

More specifically, the tented face mask construction comprises a face covering portion constructed from two congruent layers of woven fabric pieces sewn together along their respective peripheries. The face covering has a central rectangular section having opposed side edges and upper and lower edges extending between the opposed side edges. The upper tent portion has a proximal edge extending along the upper edge of the central rectangular portion so that the upper tent portion extends substantially perpendicularly away from the upper edge of the central rectangular section toward a distal edge. Likewise, a lower tent portion having a proximal edge extends along the lower edge of the central rectangular portion. The lower tent portion extends substantially away from the upper edge of the central rectangular section toward a distal edge. To create the tenting effect, the distal edges of the upper and lower tent portions are shorter than the proximal edges of the of the upper and lower tent portions such that the upper and lower tent potions hold the opposed side edges of the central rectangular section toward one another so as to form a pouch. The upper tent portion extends over a user's nose, the lower tent portion extends under a user's chin and the central rectangular portion is supported with an air space from a user's mouth. The tented construction is achieved from the two-layer face covering through the use of fabric folds and structural seams using a unique method of folding and creasing that also provides a pouch that includes corner pockets for holding a disposable paper filter adjacent to the inside of the central rectangular portion. As noted, ear loop bands extend from each of the two opposed side edges of the face covering and are attached along a portion of the top and bottom edges that define the central rectangular section. Each ear loop comprising a flat elastic band that had two distal ends, one distal end sewn along the upper edge of the face covering and the other distal end sewn along the bottom edge of the face covering. A connecting band is provided in the form of a flat elastic band with two distal ends. The two distal ends of the connecting band are each looped around one of the ear loops and sewn to the connecting band so that the connection band is secured to the ear loops and slidable along the ear loops; wherein when the ear loops are looped around a user's ears the connecting band provides an elastic force supporting the mask member over the user's nose and mouth.

The method of constructing a tented face mask with structured seam support begins with the step of constructing a two-layer face covering by sewing two congruent layers of woven fabric pieces together along their respective peripheries. The two-layer face covering is creased to provide a central rectangular section having opposed side edges and upper and lower edges extending between the opposed side edges and upper and lower tent portions extending respectively from the upper and lower edges. The upper and lower tent sections are bent up along the creases from the central rectangular section of the woven fabric face mask and pressing and stitching along the creases. Ear loop bands are attached to the two-layer face covering along the top and bottom edges of the creases that define the central rectangular section. The upper and lower tent sections are then folded and sewn to create the tented support by folding each tent section over the rectangular section at the crease and then folding the outer half of the tent section back over the inner half of the respective tent section and then stitching the edge of the folded upper portion to be substantially perpendicular to the outer edges of the tent section whereby a tented construction is achieved from the two-layer face covering through the use of folding and structural seams.

A connecting band according to the invention serves to distribute elastic forces to optimize user comfort. In addition, the connecting band serves a second purpose—positioning and supporting the face covering around the wearer's neck in an optimal position. When the face covering is not in use, the connecting band supports the face covering to hang near the wearer's larynx (between the chin and sternum near the sternal ends of the clavicles). This position is optimal for many since it will not swing away from the wearer's thorax (which could cause interference and annoyance when eating or leaning over.). This optimal positioning in the non-use state is achieved by the dimensions and face covering design described herein.

### BRIEF DESCRIPTION OF THE DRAWINGS

FIG. 1 shows a perspective view of three types of mask.

FIG. 2 shows a top perspective of the masks of FIG. 1.

FIG. 3 shows a front view of the masks of FIG. 1.

FIG. 4 shows a perspective view of a tent type face mask.

FIG. 5 shows a perspective view of a pleated type face mask.

FIG. 6 shows a perspective view of a cup type face mask.

FIG. 7 shows a front view of a tent type face mask on a wearer.

FIG. 8 shows a side view of a tent type face mask on a wearer.

FIG. 8A shows details of the ear loops and connecting band of a mask.

FIG. 8B shows detail of the loop connection of the connecting band to an ear loop.

FIG. 9 shows a side view of a tent type face mask on a wearer depicting the elastic force.

FIG. 9A shows a front view of a tent type face mask on a wearer when the face covering is in the non-use state.

FIG. 9B shows a side view of a tent type face mask on a wearer when the face covering is not being used.

FIG. 10 shows a side view of a cup type face mask on a wearer.

FIG. 11 shows the component parts and dimensions for a tent type mask.

FIG. 12 shows Step 1 of the manufacture of a tent type mask.

FIG. 13 shows Step 2 of the manufacture of a tent type mask.

FIG. 14 shows Step 3 of the manufacture of a tent type mask.

FIG. 15 shows Step 4 of the manufacture of a tent type mask.

FIG. 16 shows Step 5 of the manufacture of a tent type mask.

FIG. 17 shows Step 6 of the manufacture of a tent type mask.

FIG. 18 shows Step 7 of the manufacture of a tent type mask.

FIG. 19 shows Step 8 of the manufacture of a tent type mask.

FIG. 20 shows Step 9 of the manufacture of a tent type mask.

FIG. 21 shows Step 10 of the manufacture of a tent type mask.

FIG. 22 shows the back view of a completed tent type mask.

FIG. 23 shows the side view of a completed tent type mask.

FIG. 24 shows the front view of a completed tent type mask.

FIG. 25 shows eight completed tent type masks in various positions.

FIG. 26 shows an elastic connection band with a snap fastener pair at each distal end.

FIG. 27 shows an alternative view of the elastic connection band of FIG. 26.

FIG. 28 shows the elastic connection band with a snap fastener pair at each distal end adjacent a tent type face covering with ear loops.

FIG. 29 shows an alternative view of the elastic connection band and face covering of FIG. 28.

FIG. 30 shows the first step of the process of attaching of the elastic connection band to the ear loops of the tent type face mask.

FIG. 31 shows the second step of the process of attaching of the elastic connection band to the ear loops of the tent type face mask.

FIG. 32 shows the third step of the process of attaching of the elastic connection band to the ear loops of the tent type face mask.

FIG. 33 shows the tent type face mask dangling from the elastic connection band connected to the ear loops of the tent type face mask.

FIG. 34 shows a side view of the elastic connection band connected to the ear loops of the tent type face mask.

FIG. 35 shows a front view of the elastic connection band connected to the ear loops of the tent type face mask.

FIG. 36 shows an elastic connection band with a Velcro fastener pair at each distal end.

FIG. 37 shows an alternative view of the elastic connection band of FIG. 36.

FIG. 38 shows the elastic connection band with a Velcro fastener pair at each distal end adjacent a tent type face covering with ear loops.

FIG. 39 shows an alternative view of the elastic connection band and face covering of FIG. 38.

FIG. 40 shows a back view of the elastic connection band and face covering of FIG. 38.

FIG. 41 shows the first step of the process of attaching of the elastic connection band to the ear loops of the tent type face mask.

FIG. 42 shows the second step of the process of attaching of the elastic connection band to the ear loops of the tent type face mask.

FIG. 43 shows the third step of the process of attaching of the elastic connection band to the ear loops of the tent type face mask.

FIG. 44 shows a side view of the elastic connection band connected to the ear loops of the tent type face mask.

FIG. 45 shows a back view of the elastic connection band connected to the ear loops of the tent type face mask.

FIG. 46 shows the tent type face mask dangling from the elastic connection band connected to the ear loops of the tent type face mask.

FIG. 47 shows a back view of the elastic connection band connected to the ear loops of the tent type face mask.

### DETAILED DESCRIPTION

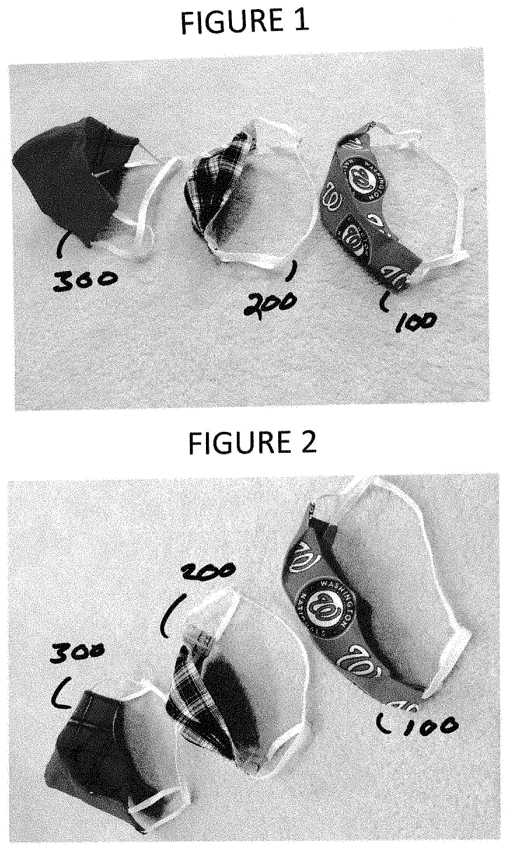

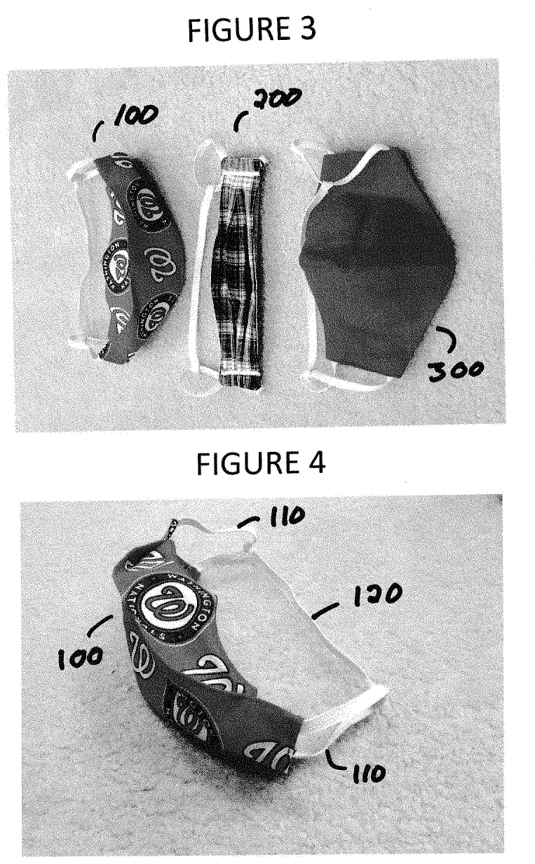

FIGS. 1-3 show various views of three types of mask, namely a tent type face mask 100, a pleated type face mask 200 and a cup type face mask 300. The masks differ in the configuration of the woven fabric facemask but are generally similar with regard to the ear loops and connecting band.

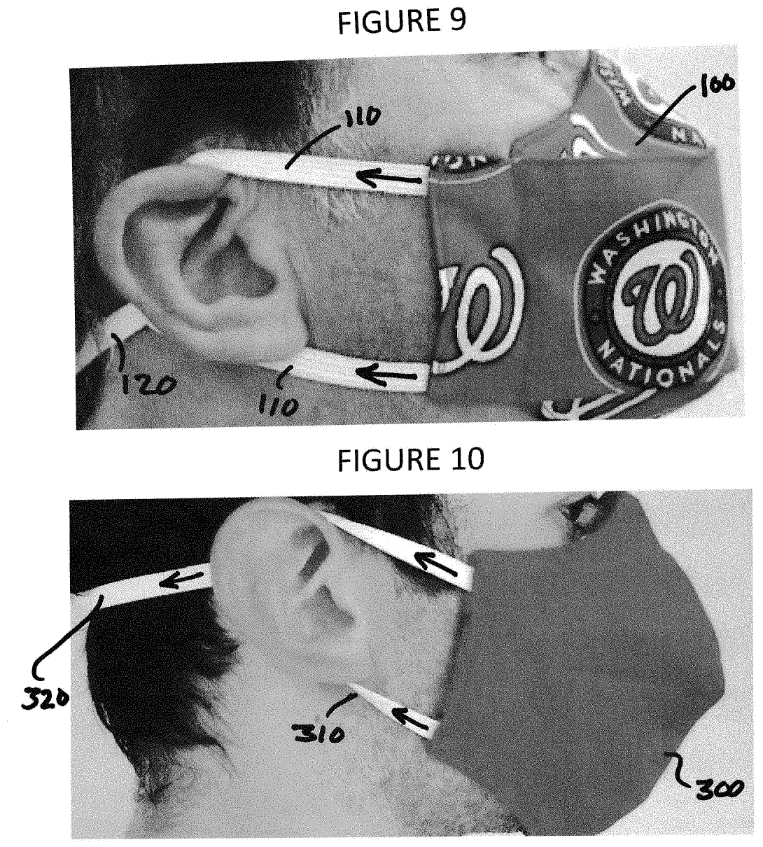

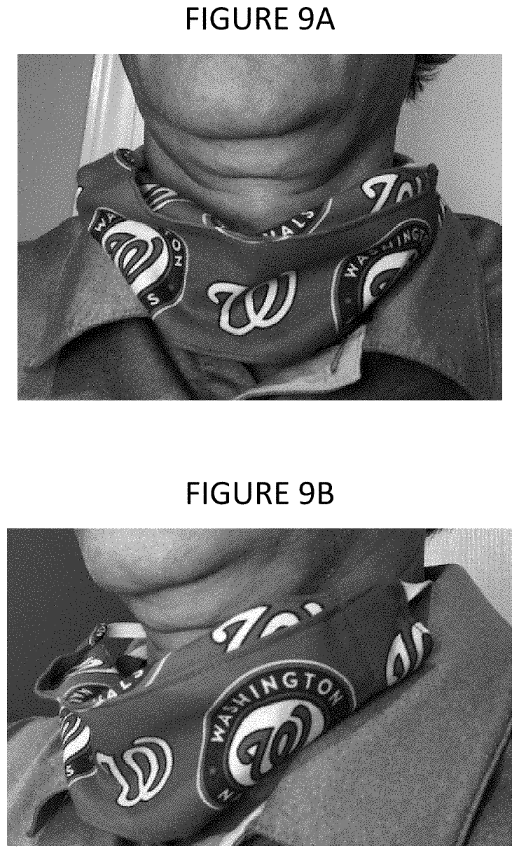

The masks are shown in greater detail in FIGS. 4-6. FIG. 4 shows a perspective view of a tent type face mask constructed using a novel method described below. When expanded the woven fabric face covering has a tented construction as shown that expands outward from two side edges and includes an upper edge and a lower edge from which the fabric mask extends outward as shown. As shown, the mask 100 includes a face covering portion that is constructed from two congruent layers of woven fabric pieces sewn together along their respective peripheries. The face covering has a central rectangular section having opposed side edges and upper and lower edges extending between the opposed side edges. The upper tent portion has a proximal edge extending along the upper edge of the central rectangular portion so that the upper tent portion extends substantially perpendicularly away from the upper edge of the central rectangular section toward a distal edge. Likewise, a lower tent portion having a proximal edge extends along the lower edge of the central rectangular portion. The lower tent portion extends substantially away from the upper edge of the central rectangular section toward a distal edge. To create the tenting effect, the distal edges of the upper and lower tent portions are shorter than the proximal edges of the of the upper and lower tent portions such that the upper and lower tent potions hold the opposed side edges of the central rectangular section toward one another so as to form a pouch. As shown well in FIG. 9, for example, the upper tent portion extends over a user's nose, the lower tent portion extends under a user's chin and the central rectangular portion is supported with an air space from a user's mouth. The tented construction is achieved from the two-layer face covering through the use of fabric folds and structural seams using a unique method of folding and creasing that also provides a pouch that includes corner pockets for holding a disposable paper filter adjacent to the inside of the central rectangular portion. As noted, ear loop bands 110 extend from each of the two opposed side edges of the face covering and are attached along a portion of the top and bottom edges that define the central rectangular section. Each ear loop comprising a flat elastic band that had two distal ends, one distal end sewn along the upper edge of the face covering and the other distal end sewn along the bottom edge of the face covering. A connecting band is provided in the form of a flat elastic band with two distal ends. The two distal ends of the connecting band are each looped around one of the ear loops and sewn to the connecting band so that the connection band is secured to the ear loops and slidable along the ear loops; wherein when the ear loops are looped around a user's ears the connecting band provides an elastic force supporting the mask member over the user's nose and mouth. One of the two ear loops is attached to each of the side edges, each ear loop comprising a flat elastic band that had two distal ends, one distal end is sewn along the upper edge and the other distal end sewn along the bottom edge. A connecting band 120 comprising a flat elastic band with two distal ends extends between the two ear loops. In particular, the two distal ends of the connecting band 120 are each looped around one of the ear loops 110 and sewn to the connecting band 120 so that the connection band is secured to the ear loops and slidable along the ear loops. By virtue of this construction, when the ear loops are looped around a wearer's ears the connecting band provides an elastic force (indicated by arrows) to the ear loops and the loops 110 and band 120 support the mask member 100 over the wearer's nose and mouth comfortably. When the wearer pulls the face covering 100 away from the nose and mouth, the band 120 supports the face covering 100 comfortably around the wearer's neck.

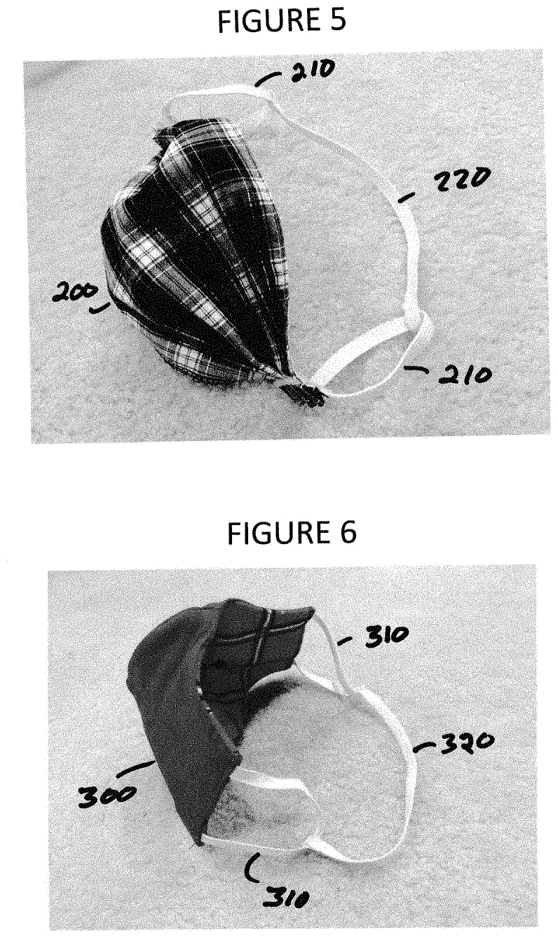

FIG. 5 shows a perspective view of a pleated type face mask. When pleated, the face covering has a generally rectangular configuration, however the pleats are sewn along the side edges, but not along the top and bottom edges. Thus, when expanded the woven fabric pleated face covering has a rounded construction as shown that expands outward from two side edges and includes an upper edge and a lower edge from which the fabric mask extends outward as shown. Two ear loops 210 are attached to the pleated woven fabric face covering 200. One of the two ear loops 210 is attached to each of the side edges, each ear loop comprising a flat elastic band that had two distal ends, one distal end is sewn along the upper edge and the other distal end sewn along the bottom edge. A connecting band 220 comprising a flat elastic band with two distal ends extends between the two ear loops. In particular, the two distal ends of the connecting band 220 are each looped around one of the ear loops 210 and sewn to the connecting band 220 so that the connection band is secured to the ear loops and slidable along the ear loops. By virtue of this construction, when the ear loops are looped around a wearer's ears the connecting band provides an elastic force to the ear loops and the loops 210 and band 220 support the mask face covering 200 over the wearer's nose and mouth comfortably. When the wearer pulls the face covering 200 away from the nose and mouth, the band 220 supports the face covering 200 comfortably around the wearer's neck.

FIG. 6 shows a perspective view of a cup type face mask. As shown, the woven fabric face covering has a cup construction that expands outward from two side edges and includes an upper edge and a lower edge from which the fabric mask extends outward as shown. Two ear loops 310 are attached to the woven fabric face covering 300. One of the two ear loops 310 is attached to each of the side edges, each ear loop comprising a flat elastic band that had two distal ends, one distal end is sewn along the upper edge and the other distal end sewn along the bottom edge. A connecting band 320 comprising a flat elastic band with two distal ends extends between the two ear loops. In particular, the two distal ends of the connecting band 320 are each looped around one of the ear loops 310 and sewn to the connecting band 320 so that the connection band is secured to the ear loops and slidable along the ear loops. By virtue of this construction, when the ear loops are looped around a wearer's ears the connecting band provides an elastic force to the ear loops and the loops 310 and band 320 support the mask member 300 over the wearer's nose and mouth comfortably. When the wearer pulls the face covering 300 away from the nose and mouth, the band 320 supports the face covering 300 comfortably around the wearer's neck.

The masks described herein all include a face covering or mask body of woven fabric material such as cotton, Lycra, polyester and the like. The face covering preferably has at least two layers of cloth. The cloth layers may be made of the same material or different materials. The woven fabric material preferably has an attractive fashionable design to encourage use. The design on the respective fabrics may differ so that, depending on the structure of the mask, the mask may be reversible. Among the common mask structures, both pleated masks 200 and fabric cup masks 300 may be reversible. The novel structured tent type mask 100 described herein is not easily reversible. Other materials may be used and additional layers of fabric may be used.

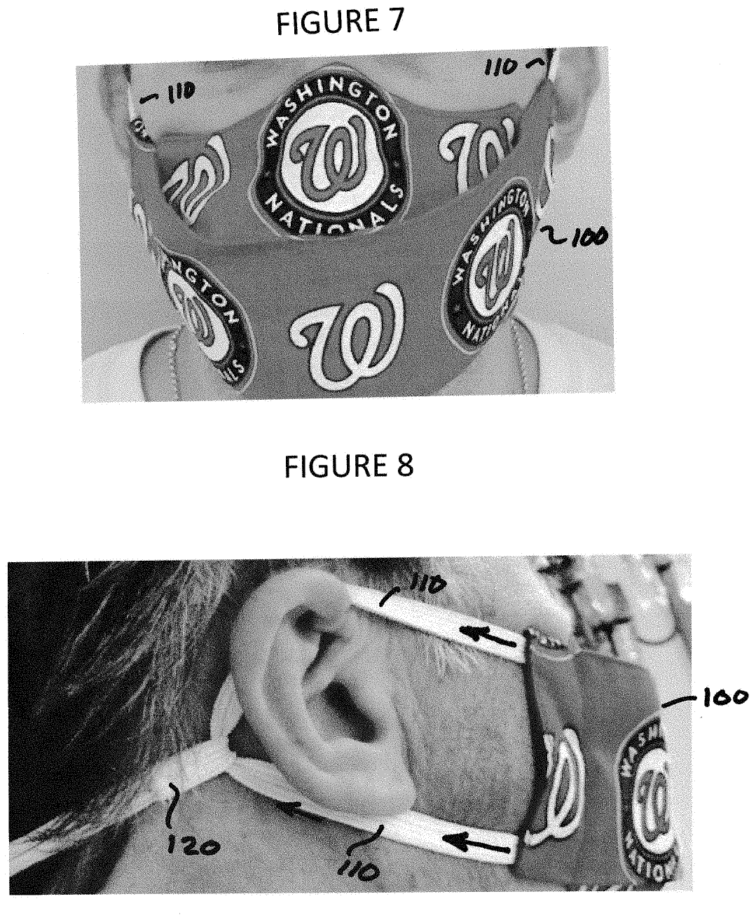

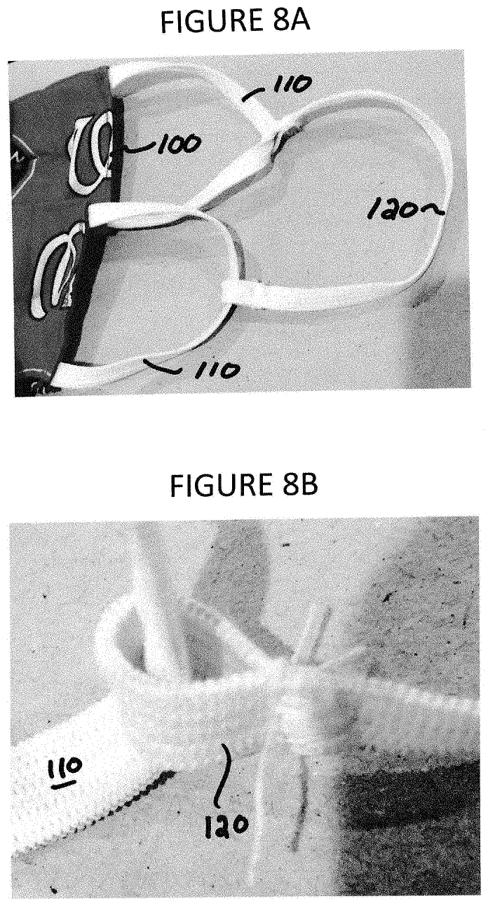

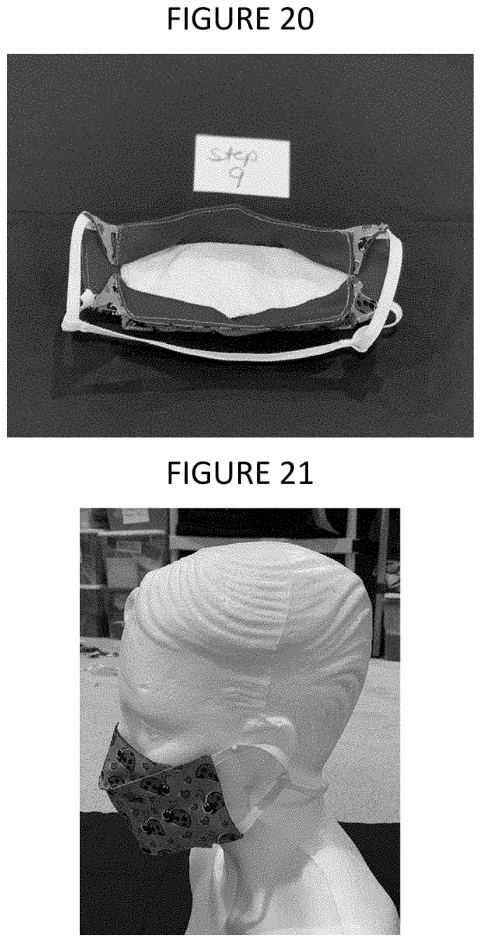

FIG. 7 shows a front view of a tent type face mask 100 on a wearer and FIG. 8 shows a side view of a tent type face mask 100 on a wearer. As shown in FIG. 7, the upper tent portion has a proximal edge extending along the upper edge of the central rectangular portion and a distal edge extending over the users' nose. From FIG. 8, it is apparent that the upper edge extends substantially perpendicular to the central rectangular portion. Woven fabric face covering masks typically have an elongated shape with an upper portion and a lower portion as well as side portions extending from corners where the side portions meet their respective upper and lower portions. As illustrated in FIG. 7. the center of the face covering 100 typically has a greater dimension at the upper and lower sides than at the side portions to accommodate the user's nose and chin. The woven fabric material allows the passage of air, providing a breathable air supply, but blocks fluid particles and droplets. Though the structured tent type face mask is formed from one two layer cloth face covering, the two layer cloth face covering is folded, creased and seamed to create a tented structure that provides an air gap in the vicinity of the wear's mouth while fitting comfortably on the wearer's nose, chin and face. The tented construction forms a pouch that includes corner pockets for holding a disposable paper filter adjacent to the inside of the central rectangular portion as shown in FIG. 20, for example.

As shown in detail in FIGS. 8, 8A and 8B, the elastic ear loops 110 are provided on each side portion of the mask 100. Each ear loop 110 comprises an elastic band have two distal ends each of which is secured, such as by sewing, to a side edge proximate a corner, i.e., one distal end is secured to the upper corner and the other distal end is secured to the lower corner. As shown, a flat elastic band 110 has two distal ends, one distal end sewn along the upper edge of the face covering 100 and the other distal end sewn along the bottom edge of the face covering 100 at the corner.

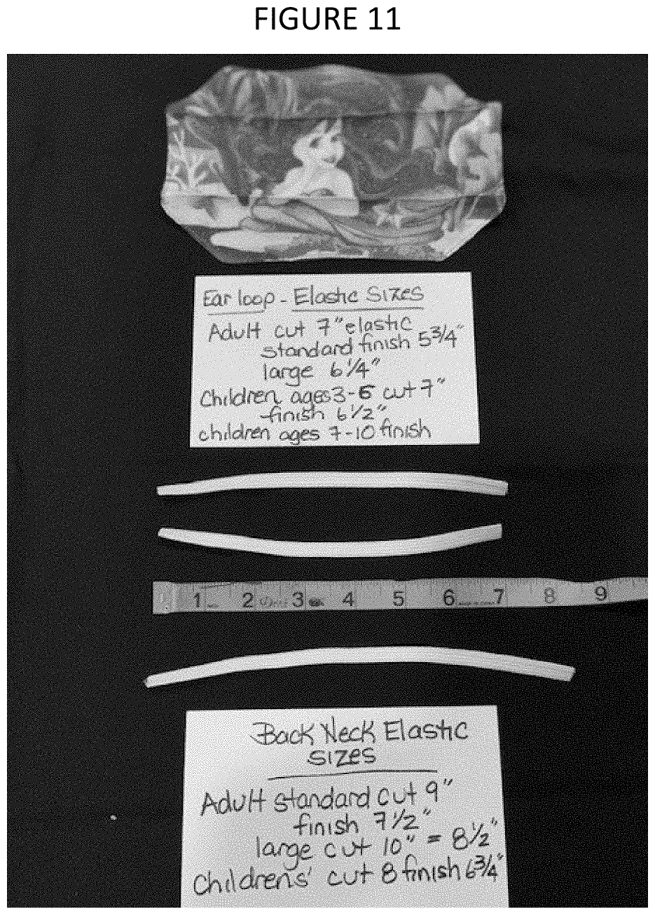

FIG. 8A shows details of the ear loops and connecting band of a mask while FIG. 8B shows detail of the loop connection of the connecting band to an ear loop. As detailed further in FIG. 11, the elastic bands for each ear loop are preferably cut to about 7″-8″ long (unstretched) inclusive of the portion secured to the woven fabric face covering and finished to 5¾ inches for standard size and 6¼ inches for adults. For example, the shorter band (7 inch) is used for a small mask and the longer band (8 inch) is used for a large mask. An elastic connecting band 120 having two distal ends extends between the two ear loops 110. At each distal end, the elastic band is formed into a loop that surrounds the elastic band of a respective ear loop. As best shown in FIG. 8B, the loop at each distal end is formed by folding and securing, such as by sewing, the end of the connecting band 120 to the band itself. The full length (unstretched) of the elastic connecting band is preferably about 9″. The elasticity of the connecting band and ear loops provides sufficient flexibility to fit a range of head sizes. Naturally, the dimensions can be altered to accommodate special cases—some of which are detailed in FIG. 11.

The elastic band for the ear loops is preferably ¼ inch or ⅛-inch-wide so that it will lay flat without concentrating the elastic force in the way an elastic cord does. For the connecting band, a width of ½ inch or ¼ inch is preferred. A wider band will provide additional, possible excess elastic force. The thin flat band with a width of ¼ inch provides sufficient width to allow the band to be secured straight onto the face covering mask so that the band is secured with stitching perpendicular to the length of the band so that the elastic force pulls the along the length of the band. In contrast, a cord like band is typically secured by turning the edge of the cord along the side edge. In such a case the elastic force of the cord creates a ripping torsional force on the seam. Attempts to attach an end of the cord along the top edge result in a weak connection between the elastic cord and the face covering. If desired, a second connecting band can be provided to allow additional adjustability to the elastic forces pulling the face covering onto the wearer's face. The addition of a second elastic connecting band makes it possible to adjust the connecting loops to alter the magnitude and direction of the elastic force experienced by the wearer to optimize comfort.

The combination of ear loops and a connecting band according to the invention provides optimum comfort and convenience because the attachment of the ear loops to the face covering and the connecting band to the ear loops optimize the direction and distribution of elastic forces when the user is wearing the mask. Moreover, when the mask is pulled down, the connecting band supports the mask near the user's larynx under the chin, which is preferable to hanging loosely near the center of the chest because it avoids the possibility of the mask swinging away from the users' body or catching something dropped from the user's mouth.

Regarding the distribution of forces, the direction of elastic forces are shown by arrows in FIGS. 8, 9 and 10. Key features here are the secure attachment of the distal ends of the ear loops with the ear loop ends extending in the direction of the upper and lower edges and the attachment of the connecting band via loops formed at the distal ends of the connecting band so that the ear loops can slide within the connecting band loops. By virtue of this combination of features the connecting band naturally slides to a position behind the user's ear (shown in FIG. 8, for example) where the elastic force of the connecting band 120 pulls the ear loops 110 away from the back side of the user's ear so that the ear loops contact the top and bottom of the user's ear instead of the back of the user's ear. Because the elastic force is essentially tangent to the ear rather than perpendicular to the ear, there is enhanced comfort. At the point of attachment there is a generally balanced elastic force (shown by arrows) pulling the mask straight in the direction of the bands as shown.

With the tent configuration of FIGS. 8 and 9, the face covering includes side portions that lay flat on the wearer's face and are tensioned by flat elastic bands pulling the side portions across the face toward the ears. The connecting band is adjustable along the ear loops to balance the elastic force of the loop ends to optimize user comfort and direct the elastic force away from the back of the ear an tangent to the top and bottom of the ear. From the side portions of the face covering that lie flat on the face, the face covering is tented outward by virtue of the construction resulting from the assembly method described below. As a result of this construction a central portion of the face covering is tented away from the wear's mouth as shown in FIG. 9. This tented configuration combined with the force distribution and balance of the connecting band optimizes the mask experience for many wearers, especially when talking.

The connecting band (120, 220, 320) shown and described here serves a second purpose—supporting the face covering around the wearer's neck in an optimal position. As shown in FIGS. 9A and 9B, for example, when the face covering is not in use, the connecting band supports the face covering to hang near the wearer's larynx (between the chin and sternum near the sternal ends of the clavicles). This position is optimal for many since it will not swing away from the wearer's thorax (which could cause interference and annoyance when eating or leaning over.). This optimal positioning in the non-use state is achieved by the dimensions and face covering design described herein. In practice, the position shown in FIGS. 9A and 9B is so comfortable that users forget they are wearing a mask—yet the mask is readily available when needed. Optimization of support when in the non-use state makes this mask construction ideal for school ages children in a classroom or similar setting.

The elastic bands used for the ear loops and connecting band each have a tensile strength, which is a measure of how much force or stress the elastic material can withstand before breaking. A wider band will have a greater tensile strength than a narrower band of the same material. The tensile strength of the bands should be strong enough to avoid failure in normal use. However, in an extraordinary situation where the band is being pulled from the back, it is desirable to ensure that the connection of the bands to the face covering will break to prevent a choking hazard. It is expected that the bands would snap or the sewn connection would fail before the face covering failed. To ensure added safety, a “fail point” may be provided in one of the bands. Since the connecting band is not directly connected to the face covering, a failure of any of the bands (ear loops or connecting band) would release force applied through all the connected bands. Thus the “fail point” may be provided on any of the bands. The “fail point” could be a mechanical snap, Velcro, a narrowing of the elastic structure or any similar structure that weakens the tensile strength at the fail point so that if the bands are stretched excessively, failure occurs at the fail point before occurring elsewhere. With a snap, Velcro or other reusable connection that band may be reused after failure. The preferred location for a fail point is on the connection band near one of the connecting loops. Some structures, such as Velcro or snaps, used to provide a fail point could also allow some adjustment of the length of the connecting band to accommodate users of different sizes.

As mentioned, FIG. 11 shows the component parts and dimensions for a tent type mask. The parts include a two-layer woven fabric cloth face mask covering, and three flat elastic bands that are about ¼ inch thick. As shown, two of the elastic bands are shorter and intended for use as ear loops, the longer band is intended for the back neck connecting band. Additional information is provided on FIG. 11 and evident from the tape measure in FIG. 11.

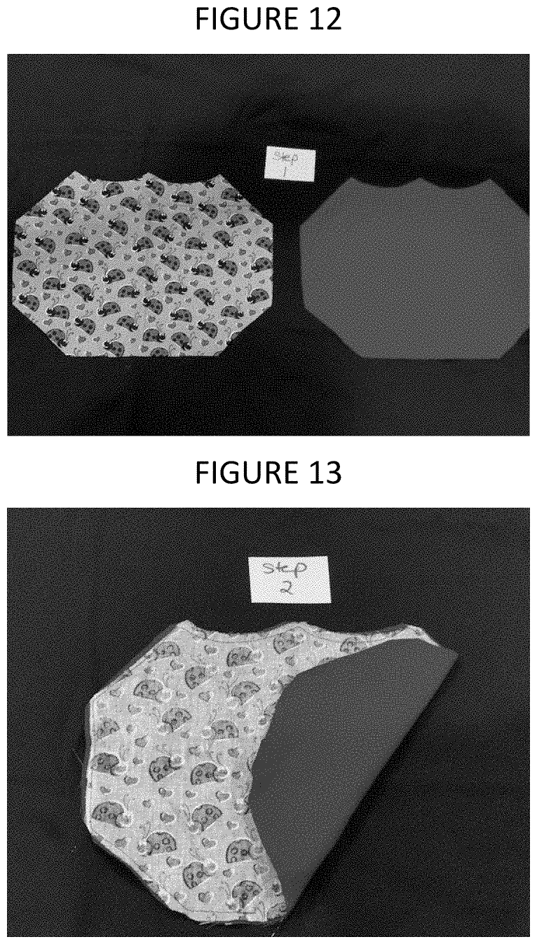

FIGS. 12-21 illustrate the step-by-step construction of a tented face covering face mask structure where tenting is achieved through a novel approach of folding creasing and seaming.

FIG. 12 shows Step 1 of the manufacture of a tent type mask, Two congruent layers of woven fabric pieces are cut, each piece has a front side (the side with a printed design and a back side).

FIG. 13 shows Step 2 of the manufacture of a tent type mask. The two congruent fabric pieces are placed together and aligned front side to front side and then sewn together along most of their common periphery leaving only a small gap to allow reversal (Step 3) and thus form a two-layer woven fabric face covering mask.

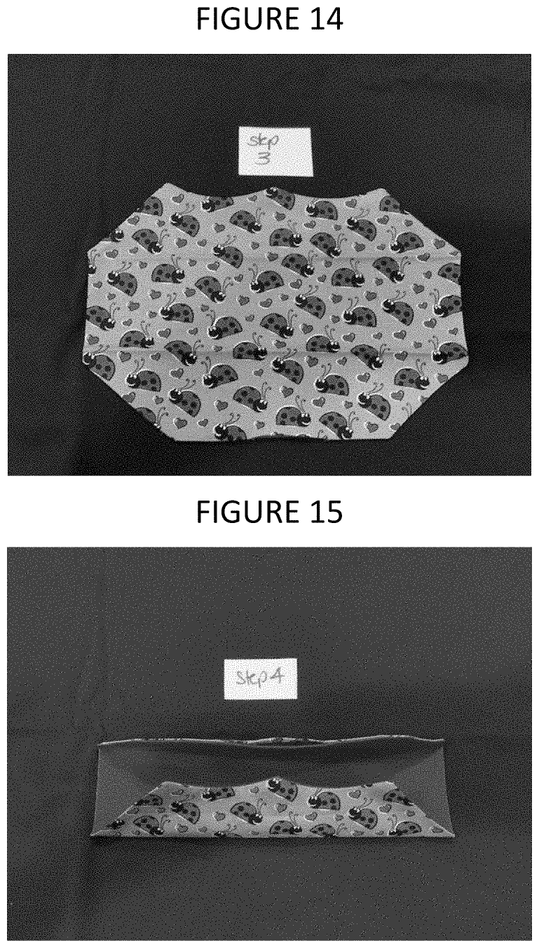

FIG. 14 shows Step 3 of the manufacture of a tent type mask. The woven fabric face mask is turned “right side out” by pulling fabric through the small gap (Step 2) and then the mask is creased to provide a central rectangular section and upper and lower “tent” sections or portions. The periphery of the mask is then top stitched along the entire periphery to provide a stronger seamed structure.

FIG. 15 shows Step 4 of the manufacture of a tent type mask. The upper and lower tent sections are bent up from the central rectangular section of the woven fabric face mask and pressed and sewn along the creases.

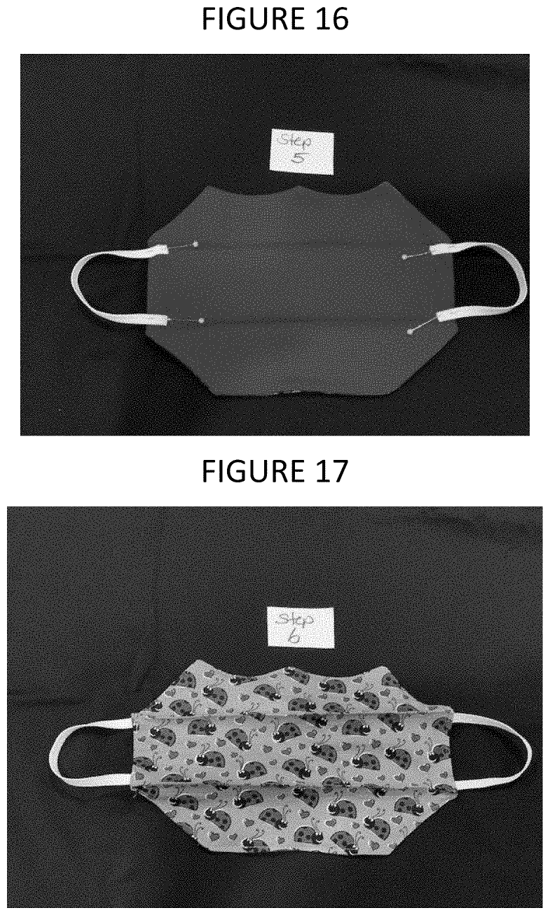

FIG. 16 shows Step 5 of the manufacture of a tent type mask. The ear loop bands are sewn to the woven fabric face mask along the top and bottom edges of the creases at the corners that define the central rectangular section of the woven fabric face mask.

FIG. 17 shows Step 6 of the manufacture of a tent type mask. The ear loop bands are sewn to the woven fabric face mask by top stitching from the opposite side of the woven fabric face mask.

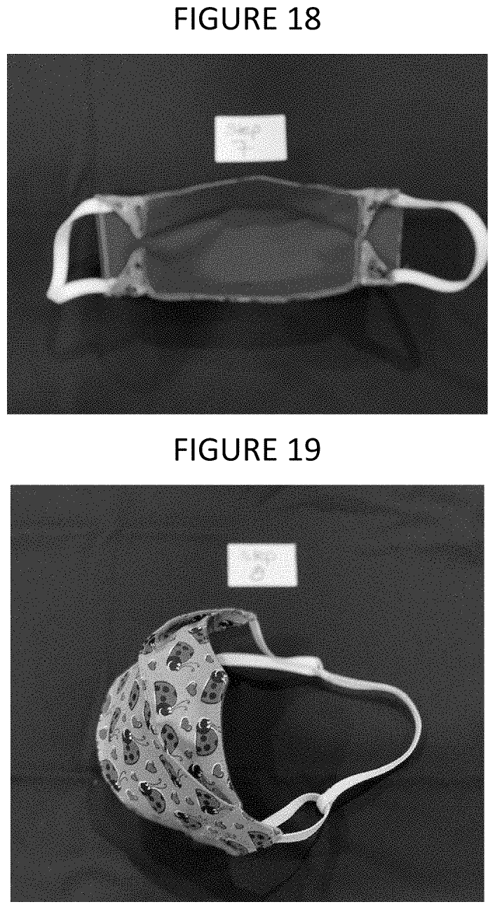

FIG. 18 shows Step 7 of the manufacture of a tent type mask. The upper and lower tent sections are folded and sewn to create the tented support. For each of the tent sections (upper and lower) the technique is the same. The tent section is folded over the rectangular section at the crease and then the outer half of the tent section is folded back over the inner half of the respective tent section, but the edge of the folded upper portion, which would ordinarily be at about 45 degrees to the upper edge is turned and stitched to be substantially perpendicular to the upper edge as shown in FIG. 18. In particular, the green fabric in FIG. 18 shows the upper and lower tent sections folded over the rectangular section the red fabric on top of the green fabric shows the outer half folded back onto the inner half with the edge aligned perpendicular to the outer edge. By virtue of this configuration a tented construction is achieved from the two-layer face covering through the use of folding and structural seams. As folded, the distal edges of the upper and lower tent portions are shorter than the proximal edges of the of the upper and lower tent portions such that the upper and lower tent potions hold the opposed side edges of the central rectangular section toward one another so as to form a pouch where the upper tent portion extends over a user's nose, the lower tent portion extends under a user's chin and the central rectangular portion is supported with an air space from a user's mouth. As shown, the upper and lower tent sections are folded down and sewn onto the central rectangular section of the woven fabric face mask to providing tenting support and provide an inner filter receiving pocket.

FIG. 19 shows Step 8 of the manufacture of a tent type mask. The woven fabric face mask is expanded to a tent shaped configuration as shown simply through the use of folding and structural seams as described. The upper tent portion and lower tent portion extend substantially perpendicular to the central rectangular section of the face covering.

FIG. 20 shows Step 9 of the manufacture of a tent type mask. Filter material is placed in the inner filter receiving pocket. The filter material could be a folded piece of paper towel or any similar filter, reusable or disposable. As shown, the filter is supported so that it is not covered by the mask (as is the case when a “pocket” is provided between mask fabric layers).

FIG. 21 shows Step 10 of the manufacture of a tent type mask. The mask is ready to wear as illustrated on the mannequin.

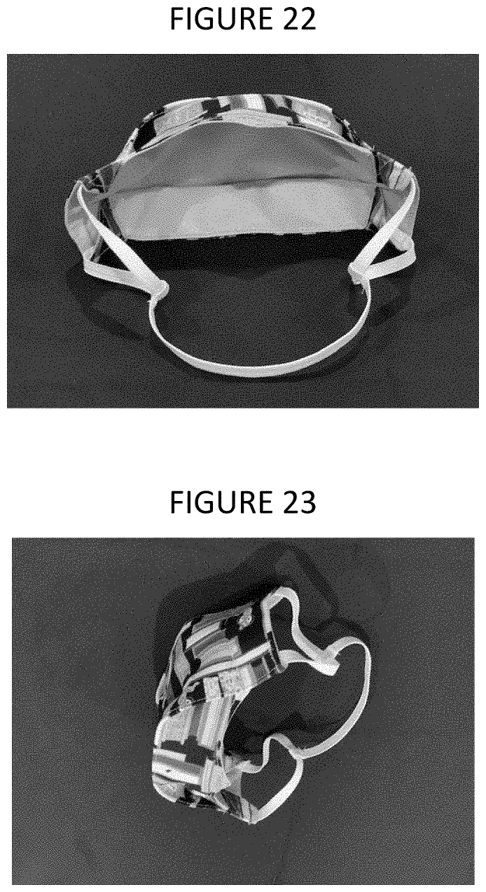

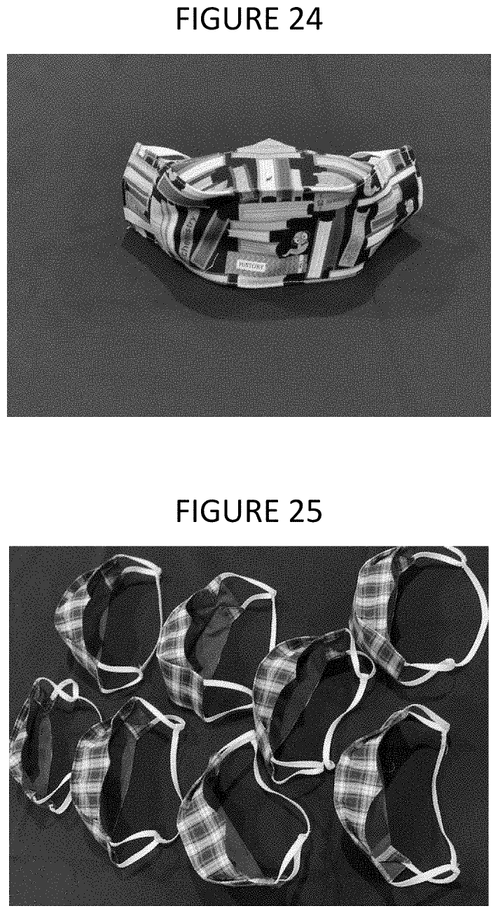

FIGS. 22-24 show various views of a completed tent type mask showing the lower tent portion and upper tent portion extending substantially perpendicular from the central rectangular portion and FIG. 25 shows eight completed tent type masks in various positions. As evident from these views, the tent type mask assembled according the foregoing method provides an optimal solution in which the two layer fabric face cover is tented away from the wear's mouth while still achieving an optimal comfort at the nose, chin and face.

As an alternative to sewn loops at the distal ends of the connection band sewn as shown in FIGS. 8A and 8B, the elastic band may have a releasable connection to provide the loop connection around the ear loops (110, 210, 310) of a face covering mask. Such an elastic connection band can be used to retrofit any mask with ear loops.

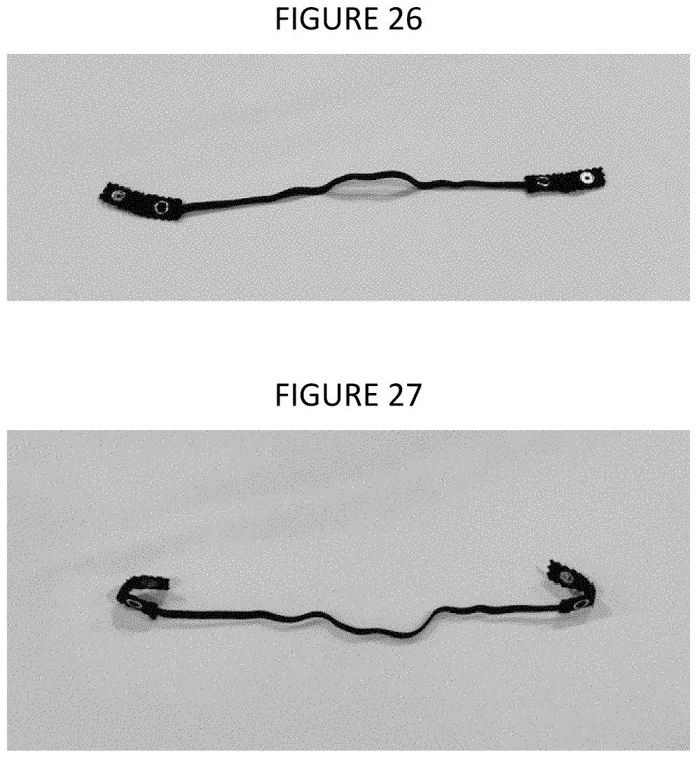

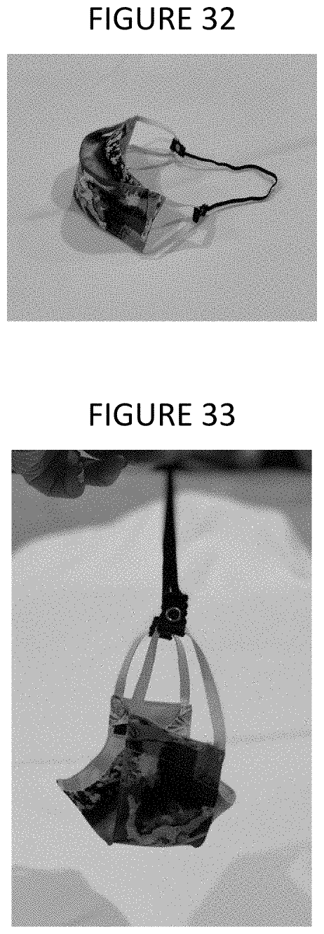

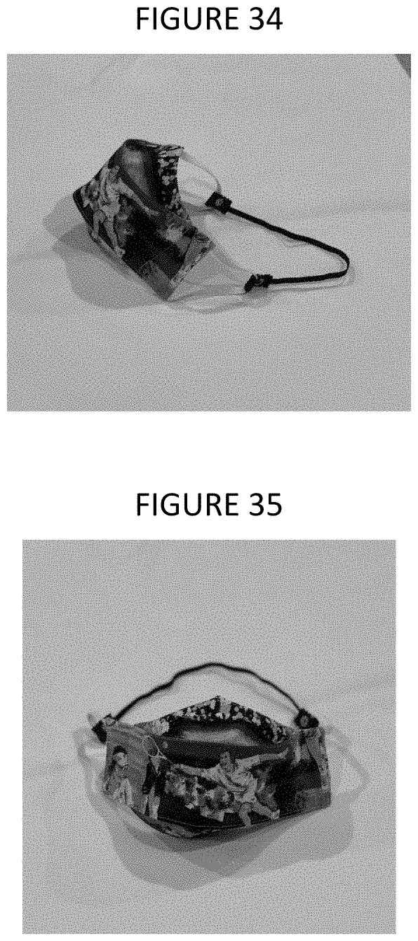

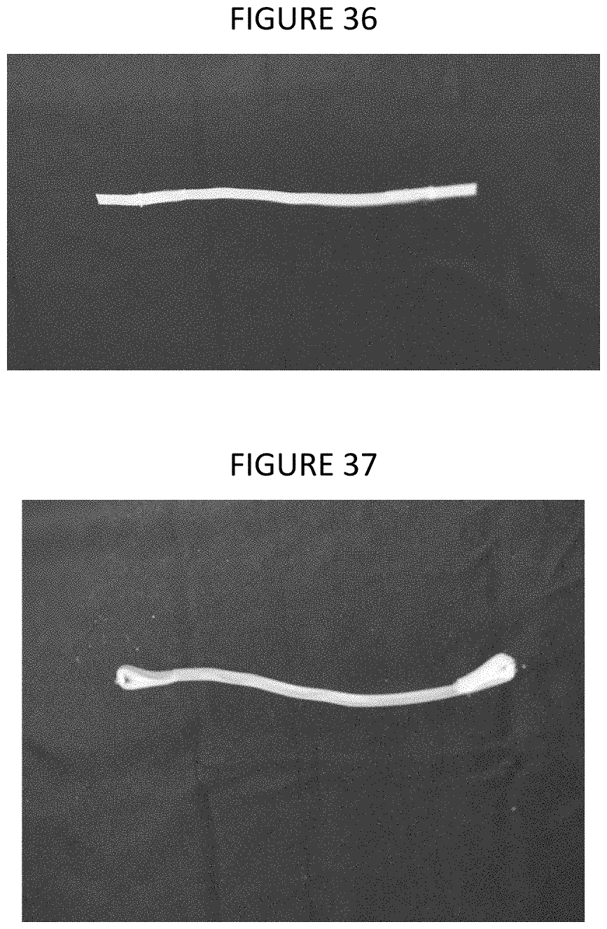

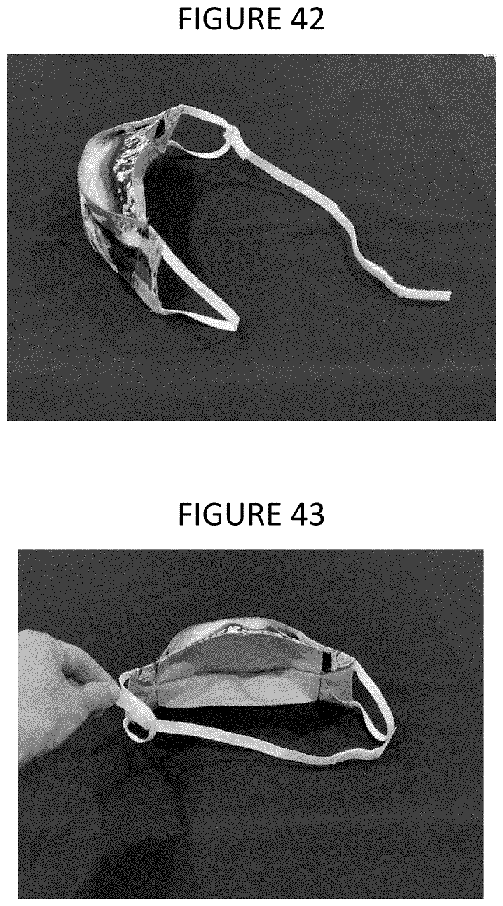

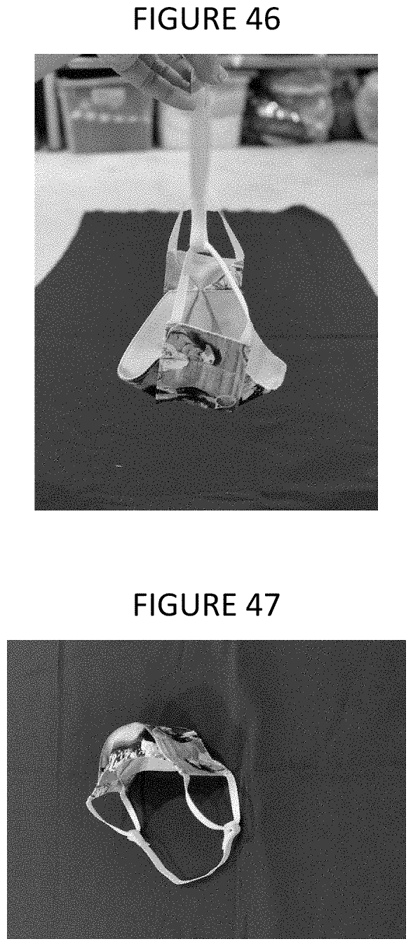

FIGS. 26-35 show the use of an elastic band with a releasable snap connection to provide the loop connection over ear loops. FIGS. 36-47 show the use of an elastic band with a releasable snap connection to provide the loop connection over ear loops.

In particular, FIGS. 26 and 27 show an elastic connection band with a snap fastener pair at each distal end. Each snap fastener includes a pair of interlocking discs, made out of a metal or plastic. A circular lip under one disc fits into a groove on the top of the other, holding them fast until a certain amount of force is applied. As noted above, a snap (or Velcro or other releasable connection) may be used to provide a fail point that will release the connection of the bands in response to excessive force. Different types of snaps can be attached to the elastic band by riveting with a punch and die set, sewing, or plying with special snap pliers.

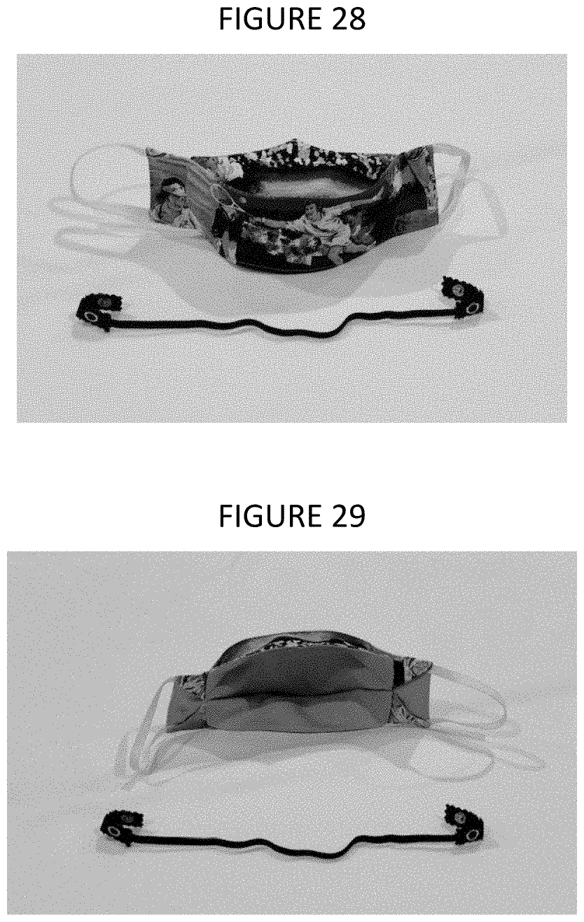

FIGS. 28 and 29 show views of the elastic connection band with a snap fastener pair at each distal end adjacent a tent type face covering with ear loops.

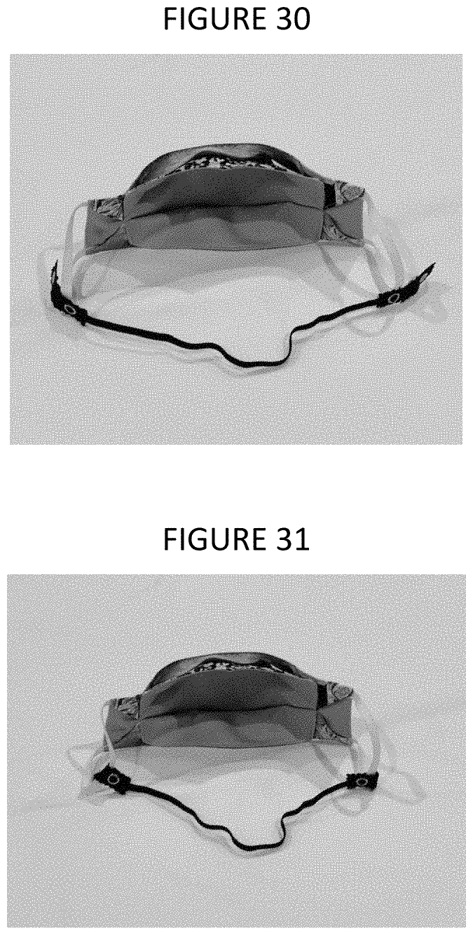

FIGS. 30-32 show in three steps the process of snapping each end of the elastic connection band to the ear loops of the tent type face mask.

FIGS. 33-35 shows the connection band connected to the ear loops of the tent type face mask.

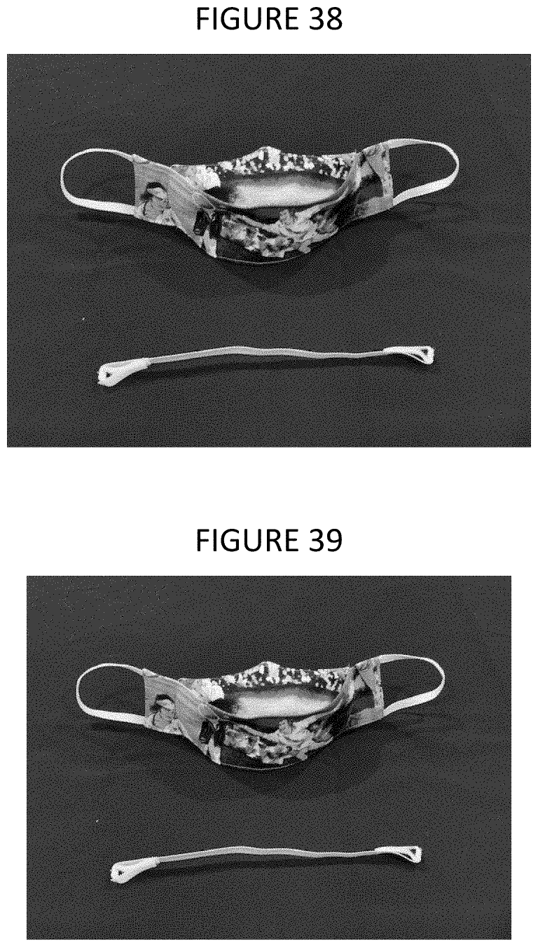

FIGS. 36 and 37 show an elastic connection band with a Velcro fastener at each distal end. FIGS. 38, 39 and 40 show views of the elastic connection band with a Velcro fastener pair at each distal end adjacent a tent type face covering with ear loops.

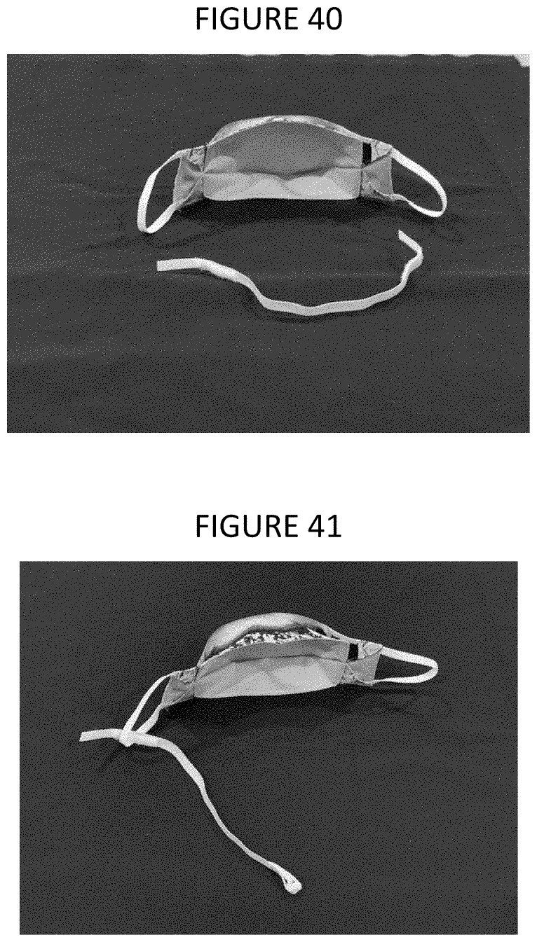

FIGS. 41-44 show the steps in the process of attaching each end of the elastic connection band to the ear loops of the tent type face mask.

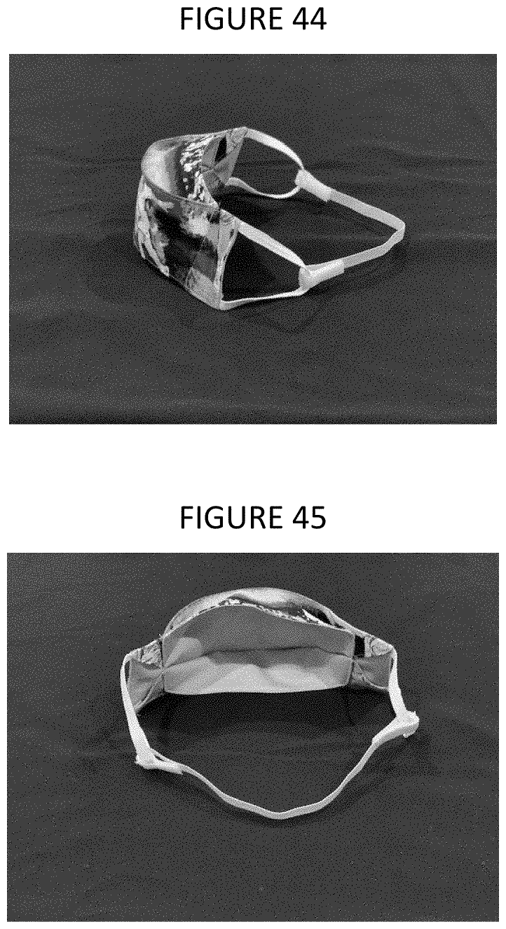

FIGS. 45-47 shows the connection band connected to the ear loops of the tent type face mask.

While numerous characteristics and advantages of the present invention have been set forth in the foregoing description, together with details of the structure and function of the invention, the disclosure is illustrative only, and the changes may be made in detail, especially in matters of shape, size and arrangement of parts within the principles of the invention to the full extent indicated by the broad general meaning of the terms in which the appended claims are expressed.

1) A mask that comprises:
(a) a face covering portion formed of a plurality of substantially congruent layers of woven fabric material sewn together along their respective peripheries and configured to cover the nose and mouth of a wearer, the face cover portion having an upper edge, a lower edge and two side edges;
(b) two ear loops, one of the two ear loops attached to each of the side edges of the face covering, each ear loop comprising a flat elastic band that had two distal ends, one distal end sewn along the upper edge of the face covering and the other distal end sewn along the bottom edge of the face covering;
(c) a connecting band comprising a flat elastic band with two distal ends, the two distal ends of the connecting band each looped around one of the ear loops and sewn to the connecting band so that the connection band is secured to the ear loops and slidable along the ear loops; wherein the ear loops are looped around a wearer's ears the connecting band provides an elastic force supporting the mask member over the wearer's nose and mouth.

2) The mask of claim 1, further comprising a pocket to hold a disposable paper filter.

3) A method of constructing a tented face mask with structured seam support comprising the steps of:
constructing a two-layer face covering by sewing two congruent layers of woven fabric pieces together along their respective peripheries;
creasing the two-layer face covering to provide a central rectangular section having opposed side edges and upper and lower edges extending between the opposed side edges and upper and lower tent portions extending respectively from the upper and lower edges;
bending the upper and lower tent sections up along the creases from the central rectangular section of the woven fabric face mask and pressing and stitching along the creases;
attaching ear loop bands to the two-layer face covering along the top and bottom edges of the creases that define the central rectangular section;
folding and sewing the upper and lower tent sections to create the tented support by folding each tent section over the rectangular section at the crease and then folding the outer half of the tent section back over the inner half of the respective tent section and then stitching the edge of the folded upper portion to be substantially perpendicular to the outer edges of the tent section whereby a tented construction is achieved from the two-layer face covering through the use of folding and structural seams.

4) A tented face mask that comprises:
a face covering portion constructed from two congruent layers of woven fabric pieces sewn together along their respective peripheries, the face covering comprising a central rectangular section having opposed side edges and upper and lower edges extending between the opposed side edges, an upper tent portion having a proximal edge extending along the upper edge of the central rectangular portion and the upper tent portion extending away from the upper edge of the central rectangular section toward a distal edge and a lower tent portion having a proximal edge extending along the lower edge of the central rectangular portion and the lower tent portion extending away from the upper edge of the central rectangular section toward a distal edge wherein the distal edges of the upper and lower tent portions are shorter than the proximal edges of the of the upper and lower tent portions such that the upper and lower tent potions hold the opposed side edges of the central rectangular section toward one another so as to form a pouch where the upper tent portion extends over a user's nose, the lower tent portion extends under a user's chin and the central rectangular portion is supported with an air space from a user's mouth;
wherein the tented construction is achieved from the two-layer face covering through the use of fabric folds and structural seams;
wherein the pouch includes corner pockets for holding a disposable paper filter adjacent to the inside of the central rectangular portion;
further comprising ear loop bands extending from each of the two opposed side edges of the face covering and attached along a portion of the top and bottom edges that define the central rectangular section, each ear loop comprising a flat elastic band that had two distal ends, one distal end sewn along the upper edge of the face covering and the other distal end sewn along the bottom edge of the face covering; and a connecting band comprising a flat elastic band with two distal ends, the two distal ends of the connecting band each looped around one of the ear loops and sewn to the connecting band so that the connection band is secured to the ear loops and slidable along the ear loops; wherein when the ear loops are looped around a user's ears the connecting band provides an elastic force supporting the mask member over the user's nose and mouth.

5) The mask of claim 1, further comprising a pocket to hold a disposable paper filter.
